(19) United States
(12) Patent Application Publication
(10) Pub. No.: US 2008/0178947 A1
(43) Pub. Date: Jul. 31, 2008

(54) Volume flow control system

(76) Inventor: Wolfgang Spreitzer, Wehingen (DE)

Correspondence Address: WALTER A. HACKLER, ph.D.;PATENT LAW OFFICE, 2372 S.E. BRISTOL STREET, SUITE B, NEWPORT BEACH, CA, 92660-0755, US

(21) Appl. No.: 12/009,737

(22) Filed: Jan. 22, 2008

(30) Foreign Application Priority Data
Jan. 29, 2007 (DE) 20 2007 001 507.0

(51) Int. Cl. G05D 7/06; F16K 31/12

(52) U.S. Cl. 137/487

(57) ABSTRACT

In accordance with the invention, a volume flow control system, in particular, for air conditioning systems and ventilation systems, for adjusting a butterfly valve that is pivotably disposed inside a flow channel, comprises a differential pressure sensor for measuring a differential pressure that prevails in the flow channel, a control unit that adjusts the butterfly valve in dependence on the pressure measured by the pressure sensor for adjusting a desired volume flow in the flow channel, and means for adjusting control parameters, wherein the means comprise a first switch for selecting one of a plurality of control parameters, and a second switch for adjusting the value of the respectively selected control parameter.

This application claims Paris Convention priority of DE 20 2007 001 507.0 filed 29 Jan. 2007, the complete disclosure of which is hereby incorporated by reference.

The present invention relates to a volume flow control system, in particular, for air conditioning systems and ventilation systems, for adjusting a butterfly valve that is pivotably disposed in the interior of a flow channel, wherein the volume flow control system comprises a differential pressure sensor for measuring the differential pressure that prevails in the flow channel, a control unit that adjusts the butterfly valve in dependence on the pressure measured by the pressure sensor for adjusting a desired volume flow in the flow channel, and means for adjusting the control parameters.

### BACKGROUND OF THE INVENTION

A volume flow control system of this type is disclosed e.g. in DE 20 2004 010 819 U1.

Volume flow control systems of this type are used to adjust a volume flow through a flow channel in air conditioning and ventilation systems. A differential pressure in the flow channel is detected by a differential pressure sensor, from which an actual value is determined. This value is compared with a stored desired value in a control means. If these differ, the control means adjusts a butterfly valve provided in the flow channel in order to correspondingly adjust the volume flow between a minimum and a maximum admissible volume flow.

The volume flow control system disclosed in DE 20 2004 010 819 U1 comprises two potentiometers for adjusting the minimum and maximum admissible volume flows. A scale that is disposed on the outside provides easy adjustment of the minimum and maximum volume flows via one potentiometer in each case. Further control parameters (e.g. “maximum measuring range”, normal or inverse direction of rotation of the butterfly valve etc.) are input and the actuating data is visualized using a separate operating element that is connected to the volume flow control system.

In contrast thereto, it is the object of the present invention to simplify the operation of a volume flow control system of the above-mentioned type.

### SUMMARY OF THE INVENTION

This object is achieved in accordance with the invention in that the means comprise a first switch for selecting one of a plurality of control parameters, and a second switch for adjusting the value of the respectively selected parameter.

By adjusting the first switch (parameter switch) a desired control parameter is selected e.g. by means of a scale that is disposed on the outside and its value is then adjusted by the second switch (adjusting potentiometer or edit switch). The two switches are preferably rotary switches or knobs with a scale disposed on the outside of the housing for the different control parameters and set values. Possible control parameters are:
Vₘᵢₙ: minimum admissible volume flow in % relating to Vₙₒₘ
Vₘₐₓ: maximum admissible volume flow in % relating to Vₙₒₘ
Vₙₒₘ: maximum measuring range/OEM-specific value corresponding to the VAV box type used
Mode: mode of operation: 0 . . . 10V; 2 . . . 10V; normal or inverse turning direction of the butterfly valve
Active flow: instantaneous volume flow in % relating to Vₙₒₘ

A display that displays the instantaneously set value of the control parameter selected by the first switch is particularly preferred. Editing is effected by changing the instantaneous position of the second switch.

Further advantages of the invention can be extracted from the description and the drawing. The features mentioned above and below may be used individually or collectively in arbitrary combination. The embodiment shown and described is not to be understood as exhaustive enumeration but has exemplary character for describing the invention.

### BRIEF DESCRIPTION OF THE DRAWING

FIG. 1 shows the top view of the inventive volume flow control system; and

FIG. 2 schematically shows the interior of the volume flow control system of FIG. 1.

### DESCRIPTION OF THE PREFERRED EMBODIMENT

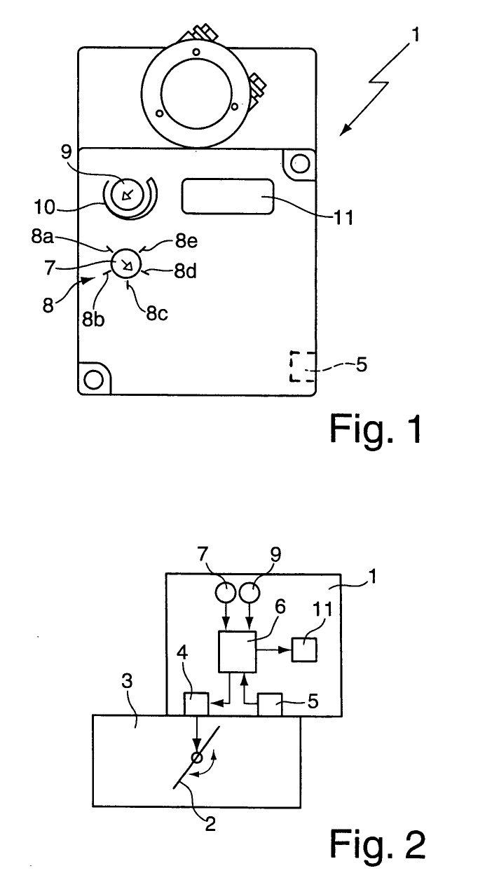

The volume flow control system 1 shown in FIGS. 1 and 2 is used to adjust a volume flow in air conditioning and ventilation systems by means of a butterfly valve 2 that is pivotably disposed inside a flow channel 3.

Towards this end, the volume flow control system 1 comprises an actuator 4 for pivoting the butterfly valve 2, a differential pressure sensor 5 for measuring a differential pressure that prevails in the flow channel 3, a control unit 6 that adjusts the actuator 4 in dependence on the pressure measured by the differential pressure sensor 5 for adjusting a desired differential pressure, i.e. a desired volume flow, that is stored in the control unit 6, in the flow channel 3.

The volume flow control system 1 moreover comprises a first rotary switch (parameter switch) 7 for selecting one of a plurality of control parameters 8a-8e of the control unit 6, and a second rotary switch (adjusting potentiometer) 9 for adjusting the value of the respectively selected control parameter. The control parameters 8a-8e of the illustrated embodiment are: Vₘᵢₙ, Vₘₐₓ, Vₙₒₘ, mode and active flow. A scale 8 with the control parameters 8a-8e and a scale 10 that displays the direction of rotation of the adjusting potentiometer 9 for an increase or a decrease are disposed on the outer side of the housing. A further display 11 is also provided that displays the instantaneously adjusted value of the control parameter selected by the parameter switch 7.

By adjusting the parameter switch 7, a desired control parameter is selected by means of the scale 8, whose value is displayed on the display and can be changed by turning the adjusting potentiometer 9. The values are adopted by the control unit 6 by switching to a new control parameter within 10 s. If the value is not adopted, the instantaneously valid value is displayed again on the display 11 after 10 s.

I claim:

1. Volume flow control system for air conditioning systems and ventilation systems, for adjusting a butterfly valve that is pivotably disposed inside a flow channel, the system comprising:
a differential pressure sensor for measuring a differential pressure that prevails in the flow channel,
a control unit that adjusts the butterfly valve in dependence on the pressure measured by the pressure sensor for adjusting a desired volume flow in the flow channel,
and means for adjusting control parameters,
wherein the means comprise a first switch for selecting one of a plurality of control parameters, and a second switch for adjusting the value of the respectively selected control parameter.

2. Volume flow control system according to claim 1, wherein the control parameters are selected from the group consisting of the parameters “minimum admissible volume flow”, “maximum admissible volume flow”, “maximum measuring range”, “operating mode” and “active flow”, or any combinations thereof.

3. Volume flow control system according to claim 1, wherein the first switch is a rotary switch or a rotary knob.

4. Volume flow control system according to claim 1, wherein the second switch is a rotary switch or a rotary knob.

5. Volume flow control system according to claim 1, wherein the first switch is associated with a scale with the control parameters that can be selected.

6. Volume flow control system a according to claim 1, wherein the second switch is associated with a scale that displays the switching direction of the second switch as to whether the value increases or decreases.

7. Volume flow control system according to claim 1, wherein a display is provided for displaying the instantaneously adjusted value of each control parameter selected by the first switch.

8. Volume flow control system according to claim 1, wherein the volume flow control system comprises an actuator for pivoting the butterfly valve.

9. Volume flow control system according to claim 2, wherein the first switch is a rotary switch or a rotary knob, wherein the second switch is a rotary switch or a rotary knob, wherein the first switch is associated with a scale with the control parameters that can be selected, wherein the second switch is associated with a scale that displays the switching direction of the second switch as to whether the value increases or decreases, wherein a display is provided for displaying the instantaneously adjusted value of each control parameter selected by the first switch, and wherein the volume flow control system comprises an actuator for pivoting the butterfly valve.
